(19) United States
(12) Patent Application Publication
(10) Pub. No.: US 2004/0017556 A1
(43) Pub. Date: Jan. 29, 2004

(54) Exposure apparatus, and device manufacturing method

(75) Inventor: Kanefumi Nakahara, Kumagaya (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Tokyo (JP)

(21) Appl. No.: 10/379,718

(22) Filed: Mar. 6, 2003

Related U.S. Application Data
(63) Continuation of application No. PCT/JP01/07740, filed on Sep. 6, 2001.

(30) Foreign Application Priority Data
Sep. 6, 2000 (JP) 2000-269521

(51) Int. Cl. G03B 27/54

(52) U.S. Cl. 355/70

(57) ABSTRACT

In an exposure apparatus, a buffer that can stock a plurality of masks and can be loaded/unloaded is disposed in a mask carrier route ranging from the load/unload ports of an SMIF pod to a mask stage RST. Furthermore, a mask carrier system carries the masks between the load/unload ports, the buffer, and the mask stage. The masks can be housed to the maximum, since the masks, which are loaded into the apparatus housed in the SMIF pod, are sequentially loaded into the buffer by the carrier system. Accordingly, the apparatus can keep the number of masks necessary for exposure at all times inside itself. In addition, since the carrier system carries the masks between the load/unload ports, the buffer, and the mask stage, the operator does not have to manually exchange the mask container.

### CROSS-REFERENCE TO RELATED APPLICATIONS

This is a continuation of International Application PCT/JP01/07740, with an international filing date of Sep. 6, 2001, the entire content of which being hereby incorporated herein by reference, which was not published in English.

### BACKGROUND OF THE INVENTION

1. Field of the Invention

The present invention relates to an exposure apparatus and a device manufacturing method, more particularly, to an exposure apparatus used in a lithographic process for producing an electronic device such as a semiconductor device or a liquid crystal display device, and a device manufacturing method using the exposure apparatus.

2. Description of the Related Art

Conventionally, in a lithographic process for producing an electronic device such as a semiconductor device or a liquid crystal display device, exposure apparatus such as a reduction projection exposure apparatus based on a step-and-repeat method and a scanning projection exposure apparatus based on a step-and-scan method (the so-called scanning stepper) have been mainly used.

Meanwhile, since the line width of the pattern subject to exposure is becoming thinner due to requirements for higher integrated semiconductor devices, not only do particles (dust) have to be kept from entering the apparatus but they also have to be kept, such as, from depositing on masks (including reticles) that are being carried. Therefore, many of the exposure apparatus these days can be equipped with a sealed type mask container for carrying the masks in a sealed state, such as, for example, a bottom open type mask container called an SMIF (Standard Mechanical Interface) pod.

Devices such as semiconductors, however, are formed overlaying over more than ten layers of circuit patterns on a substrate. Therefore, over more than ten masks have to be prepared for exposure on each layer.

As the SMIF pod, two types are well known; a single pod for a single mask, and a multi-pod for six masks. Accordingly, if three or more multi-pods are equipped in the exposure apparatus, eighteen masks (or more) can be loaded and housed in the apparatus.

Most of the conventional exposure apparatus, however, can only equip a maximum of two multi-pods, or three when including a single pod, because of the structure of the apparatus (due to the space available in the chamber where the main body of the exposure apparatus is housed). In addition, due to technical issues concerning mask control, the masks stored in the SMIF pods were returned to their original pod without fail, under the conventional operation. This made it difficult to load and stock a sufficient number of masks necessary for exposure into the exposure apparatus by automatic carriage, using only the SMIF pods. And, for these reasons, conventionally, an operator had to exchange the SMIF pods manually, depending on the progress in the exposure steps.

And, even if the exposure apparatus could be equipped with a plurality of multi-pods, it was difficult to arrange all the multi-pods so that the time required for exchanging the masks was reduced, which, as a consequence, decreased the throughput of the apparatus.

### SUMMARY OF THE INVENTION

The present invention has been made in consideration of the situation described above, and has as its first object to provide a new exposure apparatus that does not require a manual operation by an operator when exchanging the mask container.

And, it is the second object of the present invention to provide a device manufacturing method that can improve the productivity when producing highly integrated microdevices.

According to the first aspect of the present invention, there is provided an exposure apparatus comprising: an exposure apparatus main body which transfers a pattern of a mask mounted on a mask stage onto a substrate; a chamber which houses the exposure apparatus main body and has at least one load/unload port for a sealed type mask container arranged, the container capable of housing a specific number of the masks; a buffer arranged on a mask carrier route along from the load/unload port to the mask stage in which a predetermined number of masks more than the specific number of masks can be put in, taken out, and housed; and a mask carrier system which carries the mask between the load/unload port, the buffer, and the mask stage.

The load/unload port, here, refers to a load/unload port that includes both a port having a load port used only for loading the mask and an unload port used only for unloading the mask, as well as a port used for both purposes of loading and unloading the mask.

With this apparatus, the buffer is arranged on the mask carrier route along from the load/unload port of the sealed type mask container to the mask stage, and a plurality of masks can be put in, housed, or taken out whenever necessary. Therefore, even when the chamber only has one load/unload port for the mask container and only one mask container can be loaded into the port, the number of masks can be housed to the maximum in the buffer, by loading the mask container into the load/unload port several times and the mask carrier system loading the mask into the buffer from the mask container each time the mask container is loaded. Accordingly, the exposure apparatus can keep the number of masks necessary for exposure within itself at all times. In addition, since the mask carrier system carries the mask between the load/unload port, the buffer, and the mask stage, the operator does not have to manually exchange the mask container. Also, the buffer does not necessarily have to be arranged in the vicinity of the mask stage.

In this case, the exposure apparatus further comprises a suppress mechanism which suppresses contaminated materials from entering into the buffer from outside an area where the buffer is arranged.

In this description, the concept “contaminated materials” refers not only to particles (dust and dirt), but also includes impurities (such as water, vapor, ion, or organic material) that attenuates the illumination light for exposure, or clouds the optical elements having transmittance or reflecting the illumination light for exposure.

Furthermore, “suppress contaminated materials from entering” refers to a concept that includes “to stop” from entering, in addition to the normal usage of suppress, that is, “to prevent” from entering. Accordingly, the structure or the like of the suppress mechanism is not limited, and the suppress mechanism only has to consequently reduce or eliminate the amount of contaminated materials from entering into the buffer from outside an area where the buffer is arranged.

When the apparatus comprises such suppress mechanism, since the contaminated materials are suppressed from entering into the buffer by the suppress mechanism, adhesion of contaminated materials onto masks can be effectively suppressed in the case such as when the masks are housed within the buffer for a long period of time. Since the running cost of the clean room is more expensive when the degree of cleanliness is higher, in many cases the degree of cleanliness in the clean room (outside the chamber) is set lower than that of the inside of the chamber from the viewpoint of reducing the running cost, when a sealed type container such as an SMIF pod that can prevent the masks from being contaminated during carriage are used as a mask container. Therefore, the suppress mechanism above is effective in such cases.

With the exposure apparatus in the present invention, the exposure apparatus can further comprise a gas supply mechanism that can supply clean gas into the buffer. In such a case, for example, when masks are housed for over a long period of time in the buffer, adhesion of contaminated materials on the mask can be prevented or effectively suppressed by the gas supply mechanism appropriately supplying clean gas into the buffer. Likewise as above, it is especially effective when using a sealed type container such as an SMIF pod that can prevent the masks from being contaminated during carriage as a mask container.

With the exposure apparatus in the present invention, the gas supply mechanism may supply the clean gas into the buffer at all times, or the inside of the buffer may be filled with the clean and almost sealed.

With the exposure apparatus in the present invention, when it comprises the gas supply mechanism, it can further comprise an open/close portion that can open and close arranged in the chamber. In this case, the gas supply mechanism may supply the clean gas into the buffer at all times regardless of the state of the open/close portion, or it may supply the clean gas to the buffer only while the open/close portion is open. Or, the gas supply mechanism may fill the buffer with the clean gas before the open/close portion is opened, and a state almost sealed may be created in the buffer.

With the exposure apparatus in the present invention, when it comprises the gas supply mechanism and the open/close portion, the buffer can have an open/close mechanism that can open and close, and the gas supply mechanism can supply the clean gas into the buffer at least when the open/close mechanism is open. That is, the gas supply mechanism may supply the clean gas into the buffer at all times, regardless of the state of the open/close mechanism, or it may supply the clean gas into the buffer only while the open/close mechanism is open. Especially in the latter case, the buffer may be filled with the clean gas in a state almost sealed, while the open/close mechanism is closed.

With the exposure apparatus in the present invention, when it comprises the gas supply mechanism and the open/close portion, the buffer may have an open/close mechanism that can open and close, and the gas supply mechanism may supply the clean gas into the buffer only while the open/close portion and the open/close mechanism are both open.

With the exposure apparatus in the present invention, when it comprises the gas supply mechanism the buffer can have an open/close mechanism that can open and close, and creates a state almost sealed within the buffer in a closed state. In this case, the gas supply mechanism can supply the clean gas into the buffer only while the open/close mechanism is open, whereas the buffer may be filled with the clean gas, while the open/close mechanism is closed.

With the exposure apparatus in the present invention, when it comprises the gas supply system, and the buffer further comprises the open/close system, the exposure apparatus can further comprise a control unit which opens and closes the open/close mechanism each time the mask is put in and taken out of the buffer, or it can further comprise a control unit which opens and closes the open/close mechanism depending on a degree of cleanliness within the chamber. In the former case, the open/close mechanism of the buffer is normally closed by the control unit, and opened only when the mask is put in or taken out of the buffer. Accordingly, contaminated materials such as particles can be kept from entering the buffer to the utmost. On the other hand, in the latter case, the control unit controls the open/close mechanism depending on the degree of cleanliness within the chamber. While the degree of cleanliness within the chamber is low and the gas inside the chamber contains a high level of contaminated material such as particles or impurities, the control unit maintains a closed state, whereas, when the degree of cleanliness within the chamber increases and the amount of contaminated materials in the gas inside the chamber decreases, the control unit switches the open/closed mechanism to an open state.

With the exposure apparatus according to the present invention, the buffer can have an open/close mechanism that can cut off its inside from outside air. By creating a positive atmosphere within the chamber to the outside air, the outside air and naturally contaminated materials such as particles concentrated in the outside air can be kept from entering the chamber. However, when the positive atmosphere cannot be maintained for some reason, the open/close mechanism cuts off the inside of the buffer form the outside air, therefore, adhesion of the contaminated materials on the mask due to the outside air entering the buffer is prevented.

In this case, the exposure apparatus can further comprise: an open close portion that can open and close arranged in the chamber; and a control unit which controls the open/close mechanism depending on a state of the open/close portion. In such a case, for example, the control unit can control the open/close mechanism so that the inside of the buffer is cut off from the outside air at least while the open/close portion is open. Even when the open/close portion is opened, for example, for reasons such as maintenance of the exposure apparatus main body in the chamber, the open/close mechanism cuts off the inside of the buffer from the outside air, therefore, adhesion of the contaminated materials on the mask due to the outside air entering the buffer is prevented.

In this case, various types of open/close mechanisms having different structures can be used as the open/close mechanism. For example, the open/close mechanism can be a barrier film consisting of a high-velocity gas flow that closes an entrance of the mask arranged at the buffer when the open/close portion is open.

With the exposure apparatus according to the present invention, when the buffer has an open/close mechanism that can cut off its inside from outside air, the exposure apparatus can further comprise a control unit which controls the open/close mechanism depending on a degree of cleanliness within the chamber. Or, the exposure apparatus can further comprise a control unit which opens and closes the open/close mechanism each time the mask is put in and taken out of the buffer.

The open/close mechanism can be structured freely as long as the mask can be isolated from the atmosphere containing particles and impurities, and is not limited to the one formed on at least one edge surface of the buffer. For example, the open/close mechanism may be structured so that a clean gas is supplied from at least one direction to cover the mask with an almost clean gas.

With the exposure apparatus according to the present invention, the buffer may be formed of a single space with a plurality of masks housed therein. Or, the buffer may comprise a plurality of spaces divided inside the buffer that can house at least one mask inside each space.

With the exposure apparatus according to the present invention, the exposure apparatus can further comprise a particle inspection unit that inspects an adhered state of the particles on the mask, the particle inspection unit arranged on a mask carrier route along from the load/unload port to the mask stage. In the exposure apparatus of the present invention, the mask is carried by the carrier system to the mask stage via the buffer from the load/unload port of the sealed type mask container. This allows the mask to be carried into the chamber in an isolated state to the outside air, as well as being carried in the chamber likewise, without having any contact with the outside air. Accordingly, adhesion of contaminated materials described earlier on the mask within the chamber is effectively suppressed. Therefore, the particle inspection performed prior to loading the mask into the buffer has to be performed only once, by the particle inspection unit.

In this case, the exposure apparatus can further comprise a reading unit that reads information regarding the mask provided on the mask, the reading unit arranged on a mask carrier route along from the load/unload port to the mask stage. In such a case, the masks can be controlled individually, based on the information read by the reading unit. Therefore, no inconvenience occurs when the masks are controlled so that only the masks having good inspection results by the particle inspection unit are loaded into the buffer, and the masks having faulty results are returned to the mask container in an available space. That is, for example, when the chamber is structured so that a plurality of mask containers can be loaded or unloaded, the mask does not necessarily have to be returned to the mask container in which it was housed, and can be housed in a different container. As a consequence, operations such as the masks in the buffers being updated to the ones corresponding to the process thereinafter becomes possible, by unloading the masks that were found faulty in the particle inspection housed in the mask container and re-loading the same type of masks.

With the exposure apparatus according to the present invention, a plurality of the mask containers can be arranged in the load/unload port, and the predetermined number of masks that can be housed in the buffer is more than a number of masks that can be housed in the plurality of mask containers.

In this case, the exposure apparatus can further comprise a suppress mechanism which suppresses contaminated materials from entering the buffer from outside the area where the buffer is arranged. Or, the exposure apparatus can further comprise a gas supply mechanism that can supply clean gas into the buffer. Or, the buffer can have an open/close mechanism that can cut off its interior from outside air. Or, the buffer can be formed of a single space with a plurality of masks housed therein. Or, the buffer can comprise a plurality of spaces that can house at least one mask inside each space. Or, the exposure apparatus can further comprise a particle inspection unit that inspects an adhered state of the particles on the mask, the particle inspection unit arranged on a mask carrier route along from the load/unload port to the mask stage.

In addition, in a lithographic process, by performing exposure using the exposure apparatus in the present invention, adhesion of contaminated materials on the masks can be prevented for over a long period of time, which effectively suppresses the decrease in exposure accuracy. This allows production of high integration devices with a good yield, leading to improvement in its productivity. Accordingly, from the aspect of the present invention, there is provided a device manufacturing method using the exposure apparatus in the present invention.

### BRIEF DESCRIPTION OF THE DRAWINGS

FIG. 1 is a perspective view entirely showing the outside of an exposure apparatus related to an embodiment in the present invention;

FIG. 2 is a partly broken side view of a main body chamber in FIG. 1 when viewed from the −Y direction to the +Y direction;

FIG. 3 is a partly omitted sectional view of a main body chamber in FIG. 1, sectioned along a surface parallel to the XY plane;

FIG. 4 is a perspective view showing a buffer used in an exposure apparatus in FIG. 1;

FIG. 5 is a block diagram briefly showing an arrangement of a control system employed in an exposure apparatus in FIG. 1;

FIG. 6 is a view showing a modified example of a buffer;

FIGS. 7A to 7C are views showing modified examples of a buffer;

FIG. 8 is a flow chart for explaining an embodiment of a device manufacturing method according to the present invention; and

FIG. 9 is a flow chart for showing a process in step 204 in FIG. 8.

### DESCRIPTION OF THE PREFERRED EMBODIMENTS

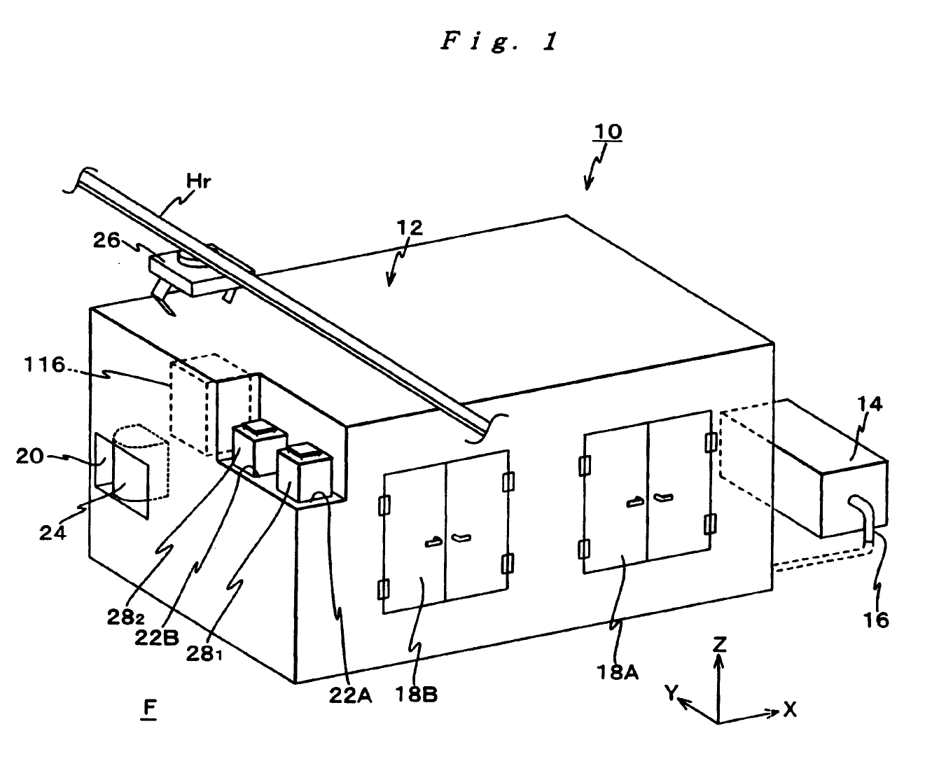

Referring to FIGS. 1 to 5, an embodiment of the present invention is described below. FIG. 1 is a schematic perspective view of an exposure apparatus related to the embodiment.

Exposure apparatus 10 is arranged on a floor surface F in a clean room where the level of cleanliness is around class 100 to 1000. Exposure apparatus 10 comprises: an environmental chamber 12 (hereinafter referred to as the “main body chamber”) serving as a chamber that houses the main body of the exposure apparatus, which will be described later; a laser unit 14 serving as a light source for exposure (exposure light source) arranged on floor surface F on one side (the +X side) in the longitudinal direction of main body chamber 12 (the X-axis direction in FIG. 1) at a predetermined interval; and a light guiding optical system 16, which optically connects the main body of the exposure apparatus in main body chamber 12 to laser unit 14, and at least a part of it includes an optical system called a beam matching unit for optical axis adjustment, and the like.

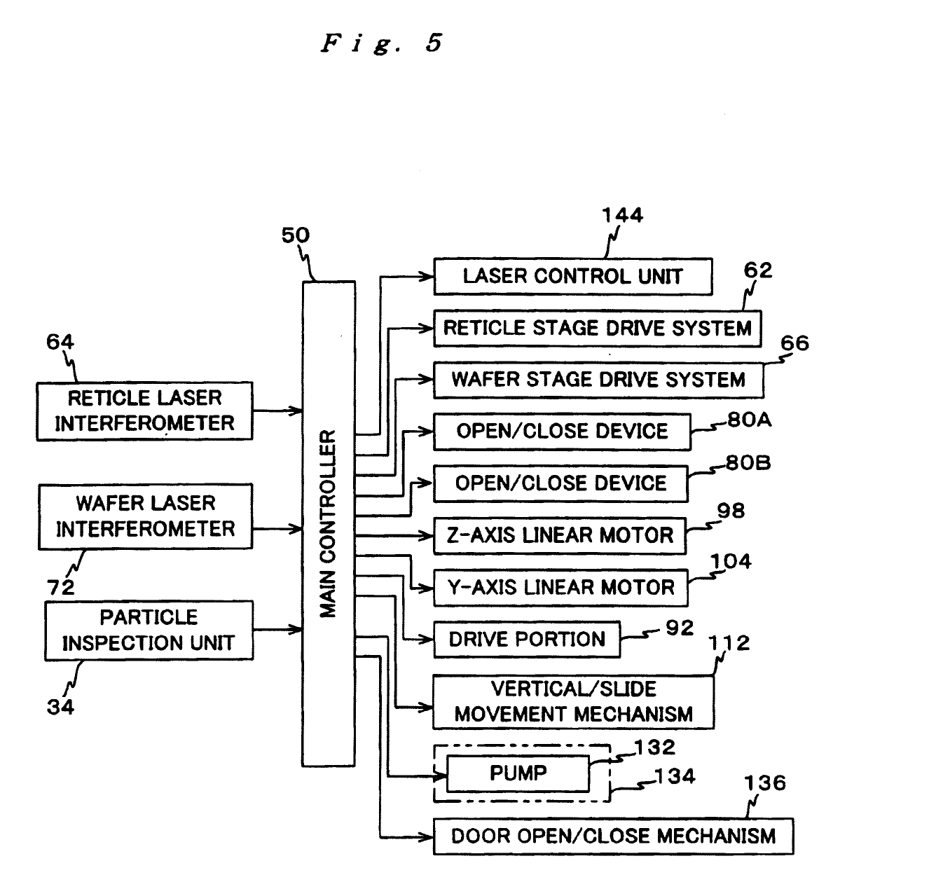

As laser unit 14, an ultraviolet pulse laser light source such as the KrF excimer laser unit, which oscillates a pulse light having a wavelength of 248 nm, or an ArF excimer laser unit, which oscillates a pulse light having a wavelength of 193 nm, is used. A laser controller 144 (not shown in FIG. 1, refer to FIG. 5) is arranged alongside laser unit 14, and laser controller 144 controls the oscillation center wavelength and the spectral line width (half-bandwidth) of the pulse ultraviolet beam emitted, the trigger timing of the pulse oscillation, and the gases in the laser chamber, and the like, in accordance with instructions from a main controller 50 (not shown in FIG. 1, refer to FIG. 5) which will be described later in the description.

On the side wall of main body chamber 12 on the −Y side in FIG. 1, two open/close doors 18A and 18B serving as an open/close portion are arranged in the X-axis direction at a predetermined interval. As these open/close doors 18A and 18B, double doors that open outward are used. One of the open/close doors, 18A, is mainly opened and closed during the maintenance period of the main body of the exposure apparatus, which will be described later, whereas, the other open/close door, 18B, is opened and closed mainly during the maintenance period of the wafer carrier system and the reticle carrier system, which serves as a mask carrier system (this system will be described later).

In addition, although it is omitted it the drawings, open/close doors having a structure similar with open/close doors 18A and 18B are arranged on the side wall on the +X side and the +Y side of main body chamber 12 in FIG. 1. This allows the main body of the exposure apparatus within main body chamber 12 to have a structure where maintenance can be performed from three directions. In this case, the maintenance area on the +X side of main body chamber 12 serves as the maintenance area for both the main body of the exposure apparatus and laser unit 14.

Other than the open/close doors arranged in main body chamber 12, the term open/close portion includes panels in the main body chamber that are simply detachable, and when other devices (such as a coater developer) or units (such as a wafer loader or a reticle loader) are connected to the main body chamber via openings, these openings are also included in the concept. That is, the open/close portion includes any structure whatsoever that can isolate the inside of the main body chamber or relieve the isolated state, with respect to the atmosphere within the clean room.

Most of light guiding optical system 16 is arranged underneath the floor surface F on which the main body chamber is arranged. Normally, the floor portion of the clean room is made up of a large number of pillars planted on the ground at a predetermined interval and meshed rectangular floor members arranged on the pillars in the shape of a matrix. Accordingly, light guiding optical system 16 can be arranged easily under the floor, by removing a few of the floor members and the pillars underneath.

Laser unit 14 may be arranged in a different chamber (service room) where the degree of cleanliness is lower than that of the clean room where main body chamber 12 is arranged. In this case, the structure of light guiding optical system 16 can be changed corresponding with the arrangement.

At a position close to the edge in the +Y direction on the side wall on the −X side of main body chamber 12, a FOUP load/unload port 20 is arranged at a height of around 900 mm above the floor. The reason for setting the height of FOUP load/unload port 20 around 900 mm above the floor, is because in the case of using a 12 inch wafer, when manual operation is a premise for bringing a Front Opening Unified Pod (hereinafter shortened to FOUP) 24 with a PGV (Personnel Guided Vehicle) propelled by an operator and loading or unloading it into the apparatus, it is most preferable from the human engineering point of view to set the height of FOUP load/unload port 20 around 900 mm above the floor. FOUP 24, in this case, houses a plurality of wafers in the vertical direction at a predetermined interval, and is an open/close type container (a sealed type wafer cassette) that has an opening on only one side and a door (cover) to open/close the opening. A carriage container of a similar type is disclosed in, for example, Japanese Patent Application Laid-open No. 08-279546.

In order to take out a wafer from FOUP 24, FOUP 24 has to be pressed onto a partition wall (not shown in Figs.) arranged on the inner side (+X side) of FOUP load/unload port 20 of main body chamber 12, and the door of FOUP 24 has to be opened/closed via an opening portion arranged in the partition wall. Therefore, in the embodiment, an open/close device (door opener) for the door of FOUP 24 is arranged on the +X side of the partition wall (within main body chamber 12). The door of FOUP 24 is to be opened/closed with the open/close device, in a state where the inside of FOUP 24 is cut off from outside air. Such details are disclosed in, for example, Japanese Patent Application Laid-open No. 08-279546 referred to above, and the operation is performed likewise in this embodiment.

A recessed portion is formed on the upper portion on the −Y side of the portion where FOUP load/unload port 20 of main body chamber 12 is arranged. And, on the bottom portion of the recessed portion (that is, the ceiling portion of main body chamber 12 corresponding to the recessed portion), load/unload ports 22A and 22B for mask containers are arranged in the Y-axis direction at a predetermined interval. Reticles serving as masks are loaded into these load/unload ports 22A and 22B by an overhead carrier system, which will be described later in the description, in a state where the reticles are each housed in reticle carriers 28₁ and 28₂ serving as mask containers. In addition, the reticles are unloaded from load/unload ports 22A and 22B by the overhead carrier system, which will be described later in the description, in a state where the reticles are each housed in reticle carriers 28₁ and 28₂.

On the ceiling portion of the clean room located almost immediately above load/unload ports 22A and 22B, a guide rail Hr, which is a track in an overhead carrier system called an OHV (Overhead Vehicle) or an OHT (Overhead Hoist Transport) for carrying the reticles in a housed state in the reticle carrier (hereinafter generally referred to as “OHV”), extends along the Y-axis direction.

As reticle carriers 28₁ and 28₂, an SMIF (Standard Mechanical Interface) pod, which is a bottom-open type sealed container that can house a plurality of reticles in the vertical direction at a predetermined interval, is used. Reticle carriers 28₁ and 28₂ will be described further, later in the description.

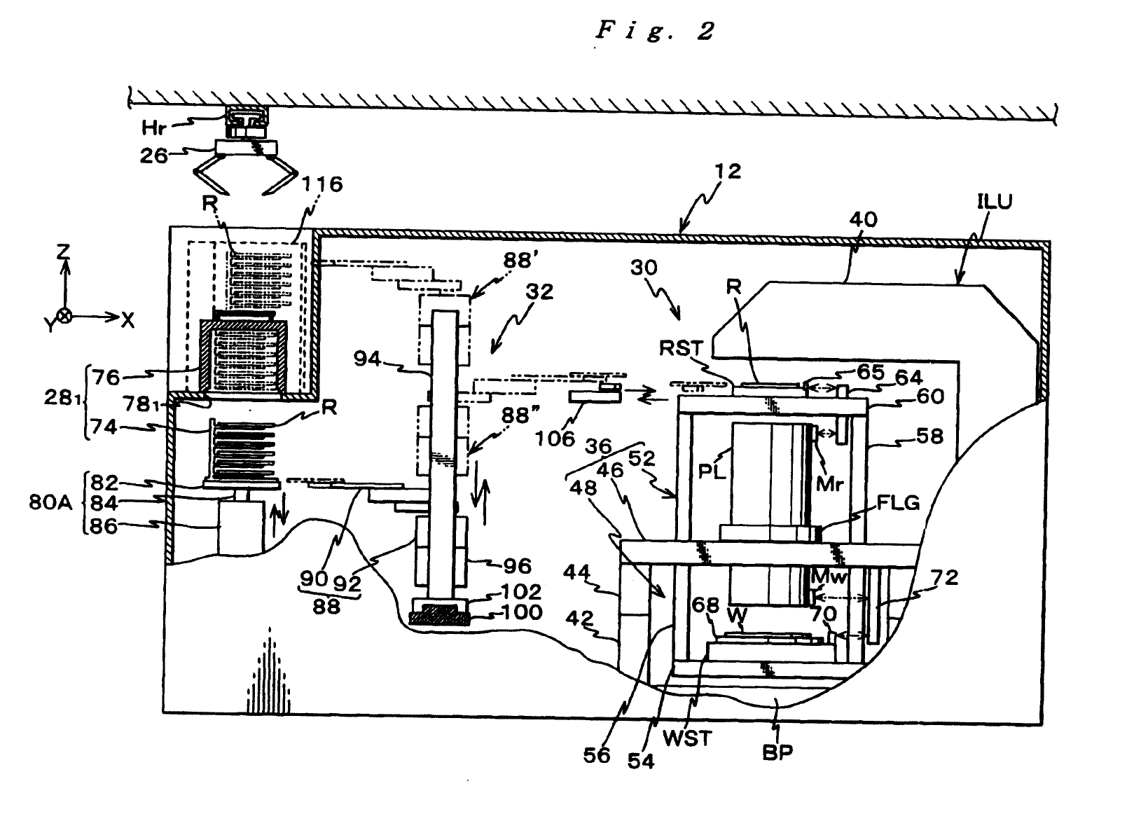

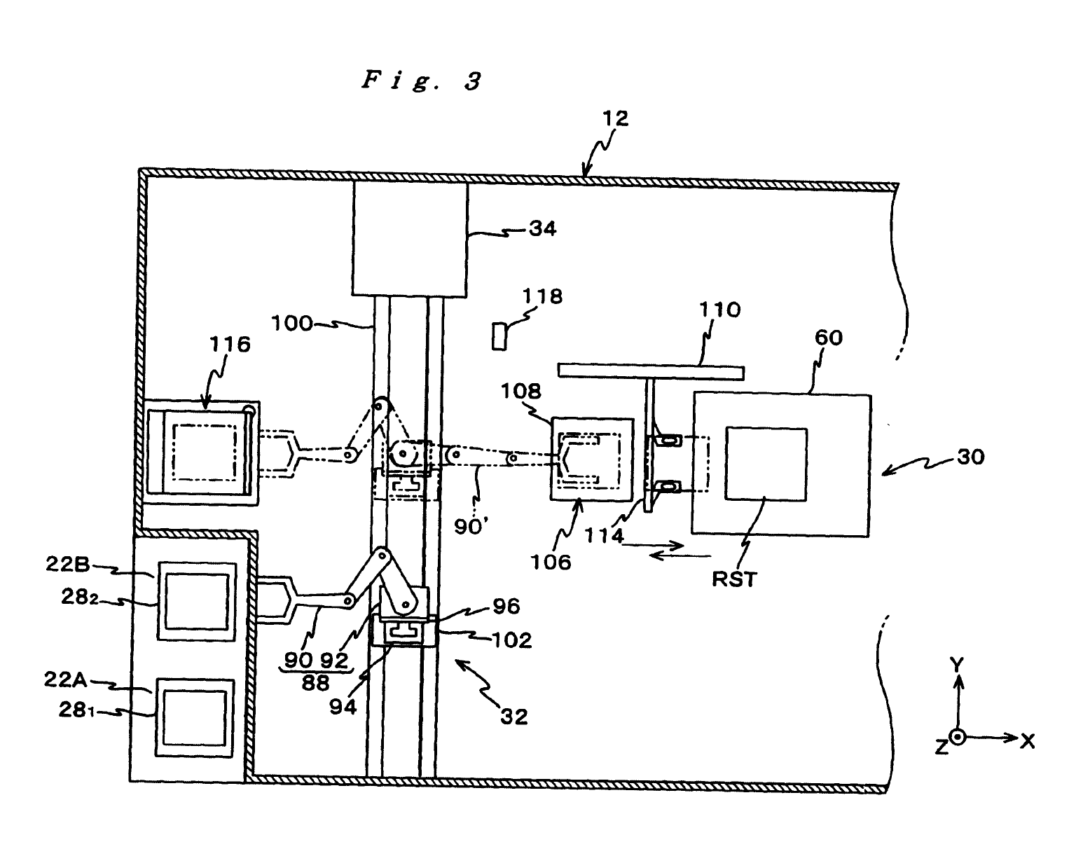

FIG. 2 is a side view of main body chamber 12 in FIG. 1, partly fragmented and viewed from the −Y direction toward the +Y direction. In addition, in FIG. 3, a partly omitted sectional view is indicated along a surface parallel to the XY plane of main body chamber 12. The structure of each section in main body chamber 12 will be described below, referring to FIGS. 2 and 3.

Within main body chamber 12, as is shown in FIGS. 2 and 3, an exposure apparatus main body 30, a reticle carrier system 32 serving as a mask carrier system, a particle inspection unit 34, and a wafer carrier system (not shown in Figs.), and the like are housed.

As is shown in FIG. 2, exposure apparatus main body 30 comprises: an illumination unit ILU for illuminating a pulse ultraviolet light from laser unit 14 onto a reticle R; a reticle stage RST serving as a mask stage for holding reticle R; a projection optical system PL for projecting an illumination light (pulse ultraviolet light) emitted from reticle R onto a wafer W; and a wafer stage WST serving as a substrate stage for holding wafer W, and the like. Furthermore, exposure apparatus main body 30 comprises a main body column 36 or the like, for holding reticle stage RST, projection optical system PL, and wafer stage WST, or the like.

Illumination unit ILU comprises, for example, an illumination system housing 40, and in illumination system housing 40 parts such as a variable beam attenuator, a beam shaping optical system, an optical integrator (such as a fly-eye lens, a rod integrator (internal reflection type), and a diffraction optical element), a beam condensing optical system, a vibration mirror, an illumination system aperture stop plate, a relay lens system, a reticle blind, a main condenser lens, a mirror, and a lens system, are arranged in a predetermined positional relationship. Illumination unit ILU illuminates a predetermined illumination area (a rectangular shaped or slit-shaped illumination area extending linearly in the Y-axis direction) on reticle R held on reticle stage RST with a uniform illuminance distribution. The rectangular slit-shaped illumination light irradiated on reticle R is set so that it extends narrowly in the Y-axis direction in the center of a circular projection field of projection optical system PL in FIG. 2, and the width of the illumination light in the X-axis direction (the scanning direction) is set almost uniform.

As illumination unit ILU, a unit having a structure similar to the one disclosed in, for example, Japanese Patent Application Laid-open No. 01-259533, and the corresponding U.S. Pat. No. 5,307,207, is used. As long as the national laws in designated states or elected states, to which this international application is applied, permit, the disclosures cited above are fully incorporated herein by reference.

Main body column 36 comprises: a plurality of supporting members 42 (in this case four) arranged on a base plate BP; a barrel supporting bed 46 which is supported almost horizontally via vibration isolation units 44, respectively fixed on the upper portion of each supporting member 42; a suspended column 48 suspended down from the lower surface of barrel supporting bed 46; and a supporting column 52 arranged on barrel supporting bed 46.

Vibration isolation units 44 are each arranged in series (or in parallel) on the upper portion of supporting members 42, and are each made up including an air mount which internal pressure is adjustable and a voice coil motor. Vibration isolation units 44 isolate subtle vibration traveling from floor surface F to barrel supporting bed 46 via base plate BP and supporting members 42 at a micro-G level.

Barrel supporting bed 46 is made of a casting or the like, and a circular opening in a planar view (viewed from above) is formed around the center portion. In the opening, projection optical system PL is inserted from above, with its optical axis direction being the Z-axis direction. Around the periphery of the barrel portion of projection optical system PL, a flange FLG is provided, integrally connected to the barrel portion, and projection optical system PL is attached to barrel supporting bed 46 via flange FLG.

Suspended column 48 comprises: a wafer base supporting bed 54; and four suspended members 56 that suspend and support wafer base supporting bed 54 almost horizontally.

In addition, supporting column 52 comprises: four legs 58 that are planted on the upper surface of barrel supporting bed 46 enclosing projection optical system PL; and a reticle base supporting bed 60 supported almost horizontally with these legs 58. Also, on the upper surface of barrel supporting bed 46, supporting members (not shown in Figs.) are arranged so as to support a part of illumination unit ILU from below.

Reticle stage RST is arranged on reticle base supporting bed 60, which structures the supporting column 52. Reticle stage RST is driven by a reticle stage drive system 62 (not shown in FIG. 1, refer to FIG. 5), which includes, for example, a linear motor and the like, and in this embodiment, it is structured so that reticle R is driven linearly in the X-axis direction with large strokes on reticle base supporting bed 60, while being finely drivable in at least the Y-axis direction and the θz direction (the rotational direction in the Z-axis direction).

On a part of reticle stage RST, a movable mirror 65 is arranged for reflecting measurement beams from a reticle laser interferometer 64 serving as a positional detection unit, to measure the position and the moving amount of reticle stage RST. Reticle laser interferometer 64 is fixed to reticle base supporting bed 60, and it measures the position of reticle stage RST in the XY plane (including the θz rotation) at a resolution of, for example, around 0.1 to 1 nm. In this case, a fixed mirror Mr, which is fixed on the side surface of projection optical system PL at the upper end, serves as a reference. Incidentally, a reflection surface may be formed (corresponding to the reflection surface of movable mirror 65 referred to earlier) by mirror polish on an edge surface of reticle stage RST.

The positional information (or the velocity information) on reticle stage RST (or in other words, the reticle R) measured with reticle laser interferometer 64 is sent to main controller 50 (refer to FIG. 5). Main controller 50 basically controls reticle stage drive system 62, so that the positional information (or velocity information) output from reticle laser interferometer system 64 coincides with instruction values (target position, target velocity).

As projection optical system PL, for example, a refraction optical system that is made up of only refraction optical elements (lens element) made of quartz or fluorite, having a reduction magnification of ¼, ⅕, and ⅙, is used. This system is double telecentric on both the object surface (reticle R) side and the image surface (wafer W) side and has a circular projection field. Therefore, when pulse ultraviolet light is irradiated on reticle R, the imaging beam, which is emitted from the portion of the circuit pattern area irradiated with the pulse ultraviolet light on reticle R, enters projection optical system PL, and forms a partial inverted image of the circuit pattern, which is limited in a slit shape or a rectangular shape (polygon), in the center of the circular field on the image surface side of projection optical system PL per each irradiation of the pulse ultraviolet light. With this operation, the partial inverted image of the circuit pattern projected is reduced and transferred onto a resist layer applied on the surface of a shot area among a plurality of shot areas on wafer W that are arranged at the image forming surface of projection optical system PL.

Wafer stage WST is arranged on wafer base supporting bed 54, which structures suspended column 48, and is driven by a wafer stage drive system 66 (not shown in FIG. 2, refer to FIG. 5), which includes, for example, a linear motor and the like. Wafer stage WST is structured so that it can be driven freely in the XY plane.

On the upper surface of wafer stage WST, wafer W is fixed, via a wafer holder 68 by vacuum chucking or the like. The XY position and the rotational amount (including yawing amount, rolling amount, and pitching amount) of wafer stage WST is measured real time with a predetermined resolution, for example around 0.5-1 nm, by a wafer laser interferometer 72 which measures the positional change of a movable mirror 70 fixed on a part of wafer stage WST. A reference mirror Mw, fixed on the lower end of the barrel of the projection optical system PL, is used for reference on measurement. The measurement values of wafer laser interferometer 72 are sent to main controller 50 (refer to FIG. 5). Incidentally, a reflection surface may be formed (corresponding to the reflection surface of movable mirror 70 referred to above) by mirror polish on an edge surface of wafer stage WST.

As is shown in FIG. 2, reticle carrier 28₁, which is one of the reticle carriers, comprises: a carrier main body 74 in which a plurality of housing shelves (in this case, six) for reticle R are integrally provided in the vertical direction at a predetermined interval; a cover 76 which fits into carrier main body 74 from above; and a lock mechanism (not shown in Figs.) provided on the bottom wall of carrier main body 74 for locking cover 76.

The other reticle carrier, 28₂, is also structured in a manner similar to reticle carrier 28₁.

At load/unload ports 22A and 22B (refer to FIGS. 1 and 3) where the reticle carriers 28₁ and 28₂ are loaded, openings 78₁ and 78₂ (in FIG. 2, however, the opening 78₂ arranged in the depth of the page is omitted) that are slightly larger than carrier main body 74 of reticle carriers 28₁ and 28₂ in size are arranged in the Y-axis direction at a predetermined interval, corresponding to the structure of the reticle carriers 28₁ and 28₂.

One of the openings, opening 78₁, is usually closed with an open/close member 82 that structures an open/close device 80A shown in FIG. 2. Open/close member 82 comprises an engage/unlock mechanism (not shown) for engaging the bottom surface of carrier main body 74 loaded into load/unload port 22A by vacuum chucking or mechanical connection, as well as releasing the lock mechanism (not shown) provided in carrier main body 74.

Open/close device 80A comprises: open/close member 82; a drive shaft 84, which has open/close member 82 fixed to its upper end surface and the shaft direction being the Z-axis direction; and a drive mechanism 86 for driving drive shaft 84 in the vertical direction (the Z-axis direction). With open/close device 80A, carrier main body 74 holding the plurality of reticles can be separated from cover 76, while the inside of main body chamber 12 is isolated from the outside. On separation, the open/close mechanism of open/close member 82 releases the lock mechanism, and then when carrier main body 74 is engaged, open/close member 82 moves downward for a predetermined amount. Open/close device 80A is under the control of the main controller 50 (refer to FIG. 5).

The other opening, 78₂, is normally shut with an open/close member that structures open/close device 80B (refer to FIG. 5), which is similar to open/close device 80A described above. In addition, the carrier main body and the cover structuring the reticle carrier (for example, the reticle carrier 28₂) loaded into load/unload port 22B can be separated in a manner similar to the one described above with open/close device 80B. The open/close device 80B is under the control of main controller 50 (refer to FIG. 5).

On the +X side of open/close devices 80A and 80B in main body chamber 12, a jointed-arm robot 88 (hereinafter referred to as a “robot”) is arranged. Robot 88 comprises: an arm 90 that can expand/fold and rotate freely within the XY plane; and a drive portion 92 for driving arm 90. Robot 88 is mounted on the upper surface of a slider 96, which is shaped in a letter L in the YZ sectional plane and moves vertically along a supporting strut guide 94 extending in the Z-axis direction. Therefore, arm 90 of robot 88 can move vertically, in addition to expanding/folding and rotating freely in the XY plane. The vertical movement of slider 96 is driven by a Z-axis linear motor (refer to FIG. 5), which is made up of a mover (not shown) integrally arranged in slider 96 and a stator (also not shown) arranged inside supporting strut guide 94 extending in the Z-axis direction.

As is can be seen when viewing FIGS. 2 and 3, supporting strut 94 is arranged above a Y guide 100, which extends in the Y-axis direction within main body chamber 12. Supporting strut 94 moves along Y guide 100 integrally with a slider 102, which is fixed to the lower end surface. That is, a mover (not shown) is arranged in slider 102, whereas a stator (also not shown) structuring a Y-axis linear motor 104 (refer to FIG. 5) with the mover is arranged in Y guide 100. Thus, robot 88 is driven integrally with supporting strut 94 in the Y-axis direction, by the Y-axis linear motor 104.

In this embodiment, drive portion 92 of robot 88, Z-axis linear motor 98, Y-axis linear motor 104, and the like operate under the control of main controller 50 (refer to FIG. 5).

In addition, at a position within main body chamber 12 a predetermined distance away to the −X side from reticle base supporting bed 60, which structure supporting column 52 as is referred to earlier, an interim delivery portion 106 is arranged for temporarily mounting reticle R before loading it onto reticle stage RST. Interim delivery portion 106 is made up of a table 108, which is supported horizontally via a supporting member (not shown), and a plurality of supporting pins (omitted in Figs.) provided on table 108.

In addition, on the +Y side of interim delivery portion 106 and reticle base supporting bed 60, an X guide 110, which extends in the X-axis direction, is arranged. On X guide 110, a reticle loader 114 is arranged, consisting of an arm that is driven along X guide 100 in the X-axis direction as well as in the vertical direction within a predetermined range by a vertical/slide movement mechanism 112 (not shown in FIGS. 2 and 3, refer to FIG. 5). Reticle loader 114 operates under the control of main controller 50 (refer to FIG. 5) via vertical/slide movement mechanism 112, and carries reticle R in between interim delivery portion 106 and reticle stage RST.

As reticle loader 114, a load arm and an unload arm may be arranged so as to reduce the time required for exchanging the reticle between interim delivery portion 106 and reticle stage RST.

In addition, above the edge portion of Y guide 100 on the +Y side, particle inspection unit 34 (referred to earlier is) arranged for checking whether foreign materials (mainly particles) are adhered on reticle R or the pellicle, and if so, to check the size of the detected particles. As particle inspection unit 34, for example, a unit is used that irradiates a small spot-shaped laser beam on reticle R or the pellicle and judges from the reflection beam whether reticle R or the pellicle contains only the original pattern or have particles adhered. Particle inspection unit 34 simultaneously inspects the pattern surface and the surface on the opposite side (hereinafter refer to as the “glass surface”) of reticle R loaded by robot 88. The inspection results (such as, information on the transfer possibility of the particles) are sent to main controller 50 (refer to FIG. 5), and are also shown on a display (not shown) in a format of a map. Main controller 50 then loads only the reticles R which particle inspection results were good into a buffer 16, which will be described later, via arm 90 of robot 88. On the other hand, the reticles R found faulty in the inspection are loaded into the empty housing shelves of the reticle carrier (for example, the predetermined carrier of reticle carriers 28₁ and 28₂) that is supposed to be unloaded next, by main controller 50.

In the description above, the case has been described where both the pattern surface and the glass surface of reticle R serve as the inspection surface when particle inspection unit 34 judges whether there are any particles, and if so, their size. When, however, the pellicle is arranged on at least the pattern surface of reticle R, the inspection may be performed in a similar manner with the surface of the pellicle serving as the only inspection surface, or with at least one of the pattern surface and the glass surface of reticle R serving as the inspection surface.

When particle inspection results are good, this means a state where no particles are adhered on reticle R that can be transferred, whereas, when the particle inspection results are referred to as faulty, it means that a particle is adhered on reticle R that may possibly be transferred.

As is described above, in the embodiment, reticle R is not always returned to the same reticle carrier where it was housed when being loaded into main body chamber 12, and may be returned to a different reticle carrier. In order to keep track of such reticles, in the embodiment, a barcode reader 118 is arranged along the carrier route of reticle R to be loaded into particle inspection unit 34. Barcode reader 118 reads a barcode attached to each reticle that contains information related to the reticle. The information read with barcode reader 118 is sent to main controller 50, and main controller 50 has control over the individual reticles based on the reticle information.

Barcode reader 118 may be arranged in between the load/unload ports 22A, 22B, and a buffer 116. In addition, the information related to the reticle does not have to be recorded in a barcode, and two-dimensional codes, letters, or numbers may be used instead. In such a case, a reading unit corresponding to the system may be arranged instead of the barcode reader.

Referring back to FIG. 1, buffer 116 is arranged at a position in the −X side end of main body chamber 12 close to the center in the Y-axis direction, diagonally above the housing space of FOUP 24 which is loaded via FOUP load/unload port 20 referred to earlier. In this case, a partition wall (not shown) divides the space in which FOUP 24 is housed and buffer 116 is arranged. And, below this partition wall, the wafer carrier system (not shown) is arranged.

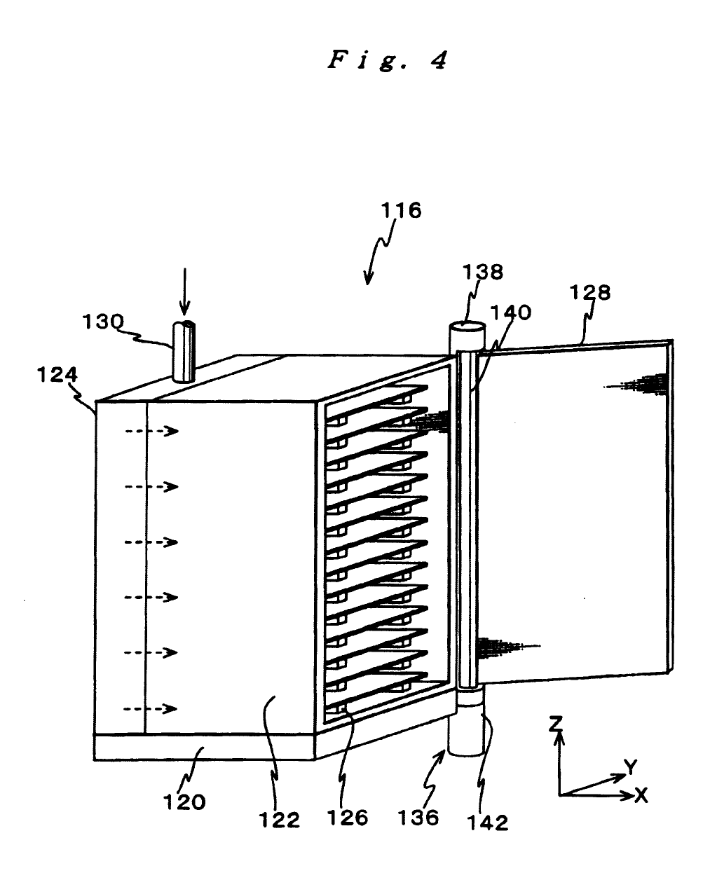

Buffer 116, in this case, is a sealed type buffer capable of housing a plurality of reticles (for example, fourteen) that can be put in/out as appropriate. More particularly, as is shown enlarged in FIG. 4, the buffer 116 comprises: a base portion 120; a buffer main body case 122, which is a box-type case fixed to base portion 120 having an opening on a surface (front side); an air exhaust mechanism 124, which is attached to the back side of buffer main body case 122; a housing shelf 126, which includes fourteen shelves arranged in the vertical direction at a predetermined interval in the inner space of buffer main body case 122; and an open/close door 128 serving as an open/close mechanism for opening/closing the front side of buffer main body case 122.

Air exhaust mechanism 124 has a case (housing) that closes the back side of buffer main body case 122. The case is hollow, with a predetermined thickness and a rectangular solid shape. On a partition wall that partitions the case from buffer main body case 122, multiple exhaust openings (not shown) are formed at a predetermined interval. Dry air is supplied inside the case that structures air exhaust mechanism 124 via an air supply piping 130, which is connected to the upper wall of the case. This dry air is supplied, for example, from a large air tank (not shown) arranged within the factory by a pump 132 (refer to FIG. 5). In this case, in the air supply route of the dry air from the air tank to air supply piping 130, an air filter for removing particles such as the HEPA filter or the ULPA filter is arranged. The air filter allows clean dry air which particles are removed to be supplied to buffer main body case 122 via air exhaust mechanism 124. And, main controller 50 (refer to FIG. 5) controls the on/off operation of pump 132.

That is, in the embodiment, the air tank, pump 132, the air supply route including air supply piping 130, and air exhaust mechanism 124 make up a gas supply mechanism 134 that is capable of supplying clean air serving as a clean gas into buffer 116, or to be more precise, buffer main body case 122. And, main controller 50 (refer to FIG. 5) controls the on/off operation when supplying the clean air with gas supply mechanism 134.

Other than supplying the clean air from the air tank as is described above, for air conditioning the inside of main body chamber 12, for example, a branch route may be arranged in the air supply route for supplying air to main body chamber 12 with an air conditioning unit, and the air can be supplied to air exhaust mechanism 124 via the branch route. Again, in this case, the air sent to air exhaust mechanism 124 is preferably air that has passed through the air filter.

Since the air inside the clean room contains impurities other than the particles such as ions or organic matters, on sending the air it is preferable to send air which impurities are removed and chemically cleaned with a chemical filter arranged. In addition, inert gas such as nitrogen or helium may be used, instead of the dry air.

Open/close door 128 is operated by a door open/close mechanism 136, which is shown in FIGS. 4 and 5. Door open/close mechanism 136 comprises: a bearing member 138, which is fixed to the edge portion on the +X side of the side wall located on the +Y side of buffer main body case 122, extending in the Z-axis direction; a supporting shaft (rotation shaft) 140 rotatably supported by bearing member 138, also extending in the Z-axis direction; and a motor box 142, which is fixed to the lower edge of bearing member 138. More particularly, bearing member 138 is made of a member having a modified cylindrical shape, in which most of it is cut off, leaving only a part of the upper end and the lower end. The sectional shape of the part removed is a ⅔ arcuated circle, with an angle at center of 240°. And supporting shaft 140 is supported via bearings, arranged on each of the upper end portion and the lower end portion of bearing member 138. In this case, since open/close door 128 is fixed to supporting shaft 140, open/close door 128 is capable of rotatably moving within the range of around 120° with supporting shaft 140 serving as the center. Motor box 142 contains a rotary motor and a deceleration mechanism for decelerating the rotation of the motor and transmitting it to supporting shaft 140. And, open/close door 128 is opened/closed with the rotary motor, which is controlled by main controller 50. In actual, opening/closing of open/close door 128 is controlled via the rotary motor as is described, however, for the sake of convenience, in the following description, opening/closing of open/close door 128 is to be performed via door open/close mechanism 136, under the control of main controller 50.

On a contact surface of buffer main body case 122 where open/close door 128 comes into contact when open/close door 128 is in a closed state, a sealing member such as a gasket (not shown) is arranged. This creates a sealed state in the inside of buffer main body case 122, when open/close door 128 is in a closed state.

FIG. 5 shows a brief configuration of a control system of exposure apparatus 10 in the embodiment. The control system is structured centering on main controller 50 that is made up of a workstation (or a microcomputer) and serves as a control unit. Other than the various controls described so far by main controller 50, main controller 50 has overall control over the entire apparatus.

Next, a series of carriage operations of the reticle and exposure operation of exposure apparatus 10 in the embodiment are schematically described.

As a premise, reticle carrier 28₂ is to be loaded into load/unload port 22B and also the reticles that were inside reticle carrier 28₂ are to be housed in buffer 116. Furthermore, carrier main body 74 making up reticle carrier 28₂ is to be supported below load/unload port 22B by open/close member 82 structuring open/close device 80B. In addition, hereinafter, to avoid the description from being complicated, the description on on/off vacuuming operation when the reticle is delivered at each point will be omitted.

a. First of all, for example, OHV 26 loads reticle carrier 28₁, which houses six reticles, into load/unload port 22A, responding to the instructions given by main controller 50. And, when main controller 50 confirms that reticle carrier 28₁ is loaded into load/unload port 22A, main controller 50 moves driving shaft 84 upward for a predetermined amount via a drive mechanism 86 structuring open/close device 80A so that open/close member 82 is engaged into carrier main body 74 of reticle carrier 28₁, while making the engage/unlock mechanism release the lock mechanism of reticle carrier 28₁. Main controller 50 then moves driving shaft 84 downward for a predetermined amount via drive mechanism 86. This moves open/close member 82 engaged into carrier main body 74 integrally downward with driving shaft 84 for a predetermined amount, and the bottom portion of reticle carrier 28₁ is released in a state where the inside of main body chamber 12 is isolated from the outside. That is, carrier main body 74 holding reticle R is separated from cover 76. FIG. 2 shows a state where carrier main body 74 is separated from cover 76. At this stage, robot 88 is waiting at a position almost opposite to open/close device 80A.

b. Next, main controller 50 inserts arm 90 underneath reticle R held on the bottom shelf of carrier main body 74 supported on open/close member 82, via drive portion 92 of robot 88. Main controller 50 then drives robot 88 slightly upward via Z-axis linear motor 98. This allows reticle R to be supported from below by arm 90.

c. Next, main controller 50 retracts arm 90 to take out reticle R from carrier main body 74 via drive portion 92, and also moves robot 88 so that it is positioned in front of particle inspection unit 34 by controlling Y-axis linear motor 104. While robot 88 is being moved, barcode reader 118 reads the information on reticle R held by arm 90, and the information is sent to the control system of particle inspection unit 34, as well as main controller 50.

d. Next, main controller 50 makes arm 90 enter particle inspection unit 34, via drive portion 92 of robot 88. After reticle R held by arm 90 is delivered to particle inspection unit 34, main controller 50 makes arm 90 withdraw outside particle inspection unit 34. The particle inspection on reticle R is then performed in particle inspection unit 34, and the inspection results are indicated on the display (not shown) and are also sent to main controller 50. The inspection results, in this case, is good, so as to simplify the description

e. After main controller 50 confirms that the results of the particle inspection are good, main controller 50 makes the 90 enter particle inspection unit 34, via drive portion 92 of robot 88. Reticle R that has completed the particle inspection is then taken out, and main controller 50 then drives robot 88 upward to a position near an imaginary line 88′ shown in FIG. 2, via Z-axis linear motor 98.

f. In parallel with driving robot 88 upward, main controller 50 opens open/close door 128 of buffer 116 via door open/close mechanism 136, and at the same time turns on pump 132 structuring gas supply mechanism 134. With this operation, the dry air begins to be supplied into buffer main body case 122 from gas exhaust mechanism 124.

g. Next, main controller 50 rotates and extends arm 90 via drive portion 92, so that arm 90 supporting reticle R enters buffer main body case 122 and is positioned above a predetermined available shelf of housing shelf 126. Main controller 50 then drives robot 88 slightly downward, and hands reticle R over to the housing shelf.

h. After the operation above has been completed, main controller 50 withdraws arm 90 from buffer main body case 122, via drive portion 92 of robot 88. Main controller 50 then closes open/close door 128 of buffer 116 via door open/close mechanism 136, and at the same time turns off pump 132 structuring gas supply mechanism 134. With this operation, the dry air supplied into buffer main body case 122 from gas exhaust mechanism 124 is stopped.

i. Main controller 50 then moves robot 88 to the position almost opposite to open/close device 80A, and repeats the above operations b. to h. Upon repetition, when the particle inspection results are good for all the reticles, the reticles in reticle carrier 28₁ are sequentially loaded into buffer 116.

j. On the other hand, main controller 50 loads the reticles that resulted faulty in the particle inspection into carrier main body 74 of reticle carrier 28₂ with robot 88, instead of loading them into buffer 116. The reason for this is because the exposure failure caused by the reticles that have the particles adhered being carried onto reticle stage RST can be prevented in advance, and also because reticle carrier 28₂ is unloaded prior to reticle carrier 28₁. In addition, main controller 50 informs a control unit of an external carriage system including units such as OHV 26 of the information on the reticle judged faulty on the particle inspection. And, according to this information, the control unit sequentially prepares a different reticle on which the same pattern as the reticle judged faulty is formed, and sequentially houses the reticles prepared in a different reticle carrier (referred to as the reticle carrier 283, for the sake of convenience) which is used to carry the remaining 13^{th} and 14^{th} reticle.

Incidentally, it is possible for an operator to check the display screen, and sequentially house a different reticle on which the same pattern as the reticle judged faulty is formed in reticle carrier 28₃ by manipulating the carrier system.

k. And, when the reticles housed in reticle carrier 28₁ are all unloaded, main controller 50 then integrates carrier main body 74 configuring reticle carrier 28₂ with cover 76 using open/close device 80B in a procedure opposite to the one described above, and waits for OHV 26 to unload reticle carrier 28₂.

l. OHV 26 then unloads reticle carrier 28₂ from the load/unload port 22B, and when this is completed, main controller 50 instructs OHV26 to load reticle carrier 283 into load/unload port 22B.

Incidentally, the operator can manually load reticle carrier 28₃ into load/unload port 22B.

m. After the loading, the reticles inside reticle carrier 28₃ are sequentially loaded into buffer main body case 122, according to the procedures similar as above.

In this manner, 14 types of the reticle R, which are planned from the beginning to be used in exposure, are stocked in the buffer main body case 122.

And when exposure is actually performed, reticle R in buffer 116 is loaded onto reticle stage RST prior to exposure in the manner described below.

n. First of all, main controller 50 drives robot 88 upward to a position near an imaginary line 88′ shown in FIG. 2, via Z-axis linear motor 98.

In parallel with driving robot 88 upward, main controller 50 opens open/close door 128 of buffer 116 via door open/close mechanism 136, and at the same time turns on pump 132 structuring gas supply mechanism 134. With this operation, the dry air begins to be supplied into buffer main body case 122 from gas exhaust mechanism 124.

o. Next, main controller 50 rotates and extends arm 90 via drive portion 92, so that arm 90 supporting reticle R enters buffer main body case 122 and is positioned underneath a predetermined shelf of housing shelf 126. Main controller 50 then drives robot 88 slightly upward, and reticle R is moved onto arm 90 from housing shelf 126. After this operation, main controller 50 withdraws arm 90 from buffer main body case 122, via drive portion 92 of robot 88. Main controller 50 then closes open/close door 128 of buffer 116 via door open/close mechanism 136, and at the same time turns off pump 132 structuring gas supply mechanism 134. With this operation, the dry air supplied into buffer main body case 122 from gas exhaust mechanism 124 is stopped.

p. Next, main controller 50 drives robot 88 downward to a position indicated with an imaginary line 88″ in FIG. 2, via Z-axis linear motor 98. Then, main controller 50 rotates and extends arm 90 via drive portion 92, and mounts reticle R onto interim delivery portion 106 (refer to the imaginary line 90′ in FIG. 3). Main controller 50 then withdraws arm 90 from interim delivery portion 106 via drive portion 92 of robot 88, and then moves reticle loader 114 to the limit position in the −X direction in addition to driving it finely upward, via vertical/slide movement mechanism 112. With this operation, reticle R mounted on interim delivery portion 106 is moved onto reticle loader 114.

q. Next, main controller 50 moves reticle loader 114 holding reticle R to the limit position in the +X direction, and carries reticle R so that it can be loaded on reticle stage RST at the loading position. FIG. 3 shows reticle loader 114 carrying reticle R. Then, after finely driving reticle loader 114 downward via vertical/slide movement mechanism 112, main controller 50 drives reticle loader 114 in the −X direction for a predetermined amount, and withdraws reticle loader 114 from above reticle base supporting bed 60.

In this manner, reticle R is loaded onto reticle stage RST.

And, when reticle R has been loaded onto reticle stage RST, main controller 50 then sets various exposure conditions for performing scanning exposure on each shot area of wafer W with an appropriate exposure amount (target exposure amount), according to the instructions from the operator.

Next, main controller 50 performs operations such as reticle alignment and baseline measurement, using a reticle microscope (not shown) and an off-axis alignment sensor (not shown), in a predetermined procedure. Then, main controller 50 performs fine alignment (such as EGA; Enhanced Global Alignment) on wafer W using the alignment sensor, and obtains the arrangement coordinates of a plurality of shot areas on wafer W.

Preparatory operations on operations such as the above reticle alignment and baseline measurement are disclosed in detail in, for example, Japanese Patent Application Laid-open No. 04-324923 and the corresponding U.S. Pat. No. 5,243,195. In addition, for EGA that follows, the details are disclosed in, for example, Japanese Patent Application Laid-open No. 61-44429 and the corresponding U.S. Pat. No. 4,780,617. As long as the national laws in designated states or elected states, to which this international application is applied, permit, the disclosures cited above are fully incorporated herein by reference.

When preparatory operations for exposing wafer W is completed in this manner, main controller 50 then moves wafer stage WST to the starting position for scanning exposure (acceleration starting position) on the first shot area of wafer W based on the alignment results, while monitoring the measurement values of wafer laser interferometer 72 and controlling wafer stage drive system 66.

Then, main controller 50 starts scanning reticle stage RST and wafer stage WST in the X-axis direction via reticle stage drives system 62 and wafer stage drive system 66. And, when both stages reach their target scanning velocity, scanning exposure begins, with the pulse ultraviolet light illuminating the pattern area of reticle R.

Prior to the scanning exposure, laser control unit 144 starts emission of laser unit 14, however, since main controller 50 synchronously controls the movement of each blade of movable blinds that make up the reticle blind unit and the movement of reticle stage RST, areas other than the pattern area on the reticle R can be kept from being irradiated with the pulse ultraviolet light.

Then, different areas of the pattern area of reticle R are sequentially illuminated with the pulse ultraviolet light, and when the entire pattern area is illuminated, scanning exposure of the first shot area on wafer W is completed. With this operation, the pattern of reticle R is reduced and transferred onto the first shot area, via projection optical system PL.

When scanning exposure on the first shot area is completed in this manner, main controller 50 steps wafer stage WST in the X-axis and Y-axis direction via wafer stage drive system 66, moving wafer stage WST to the starting position for scanning exposure (acceleration starting position) on the second shot area. Upon this stepping operation, main controller 50 measures the positional displacement of wafer stage WST in the X, Y, θz, θx, and θy directions realtime, based on the measurement values of wafer laser interferometer 72 which detects the position of wafer stage WST (or, the position of wafer W). And, based on the measurement results, main controller 50 controls the position of wafer stage WST by controlling wafer stage drive system 66, so that the XY positional displacement of wafer stage WST is in a predetermined state.

Main controller 50 then performs scanning exposure on the second shot area, in a similar manner as above.

Thus, the scanning exposure of the shot area on wafer W and the stepping operation for exposing the next shot area are repeatedly performed, and the pattern of reticle R is sequentially transferred onto all the shot areas subject to exposure on wafer W.

Meanwhile, when exposure is completed using reticle R loaded on reticle stage RST, reticle R is returned to buffer 116 in a reversed procedure of the above procedure when loading reticle R.

Hereinafter, main controller 50 takes out reticle R used for exposure whenever necessary from buffer 116 in a similar procedure as above, loads reticle R onto the reticle stage, performs exposure, and likewise returns the reticle to buffer 116 after the exposure is completed.

As is obvious from the description so far, in the embodiment, open/close devices 80A and 80B, Z-axis linear motor 98, Y-axis linear motor 104, reticle loader 114, and vertical/slide movement mechanism 112 make up a reticle carrier system 32, which serves as a mask carrier system that carries the reticle serving as a mask between the three units; load/unload ports 22A and 22B, buffer 116, and reticle stage RST.

As is described, exposure apparatus 10 of the embodiment can keep the number of reticles R required for exposure for a long time within buffer 116. In addition, since reticle carrier system 32 carries the reticle in between the three units; the load/unload ports 22A and 22B, the buffer 116, and the reticle stage RST, the reticle carriers (mask containers) do not have to be exchanged manually by the operator. Furthermore, buffer 116 does not necessarily have to be arranged in the vicinity of reticle stage RST.

In addition, when open/close door 128 is in a closed state, the inside of buffer 116 (inside buffer main body case 122) can be maintained in a state sealed from the outside. Therefore, contaminated materials such as particles or impurities can be kept from entering buffer 116 with the outside air, and adhering on the reticle R. Also, when reticle R is placed in or taken out of buffer 16, open/close door 128 is naturally opened. When open/close door 128 is opened, however, main controller 50 simultaneously supplies clean dry air into buffer 116 via gas supply mechanism 134, and continues to supply the dry air at all times while open/close door 128 is open. This effectively prevents the contaminated materials such as the particles or impurities from being adhered on the reticle, even when reticle R is being placed in or taken out of buffer 16.

The inside of main body chamber 12 where exposure apparatus main body 30 is arranged, however, is normally maintained at a predetermined target temperature and target pressure by an air conditioning unit (not shown), and the degree of cleanliness is also maintained at class 1 level. Moreover, since the inside of main body chamber 12 is normally maintained at a positive pressure with respect to the outside, the inside is free of contaminated materials such as particles entering into the main body chamber with the outside air. Therefore, buffer 116 does not necessarily have to be of a sealed structure. And, gas supply mechanism 134 also does not necessarily have to be provided, for the same reasons as above.

It is inevitable, however, for the degree of cleanliness inside main body chamber 12 to decrease during periods such as the maintenance period of exposure apparatus main body 30 or reticle carrier system 32, since openings that are large such as open/close doors 18A and 18B are opened.

However, with exposure apparatus 10 of the embodiment, since buffer 116 is a sealed type container and open/close door 128 is opened only when the reticle is put in or taken out, adhesion of contaminated materials such as particles on the reticles housed within buffer 116 can be prevented in all probability, even if the degree of cleanliness decreases inside main body chamber 12 during maintenance.

In addition, in exposure apparatus 10 of the embodiment, as is previously described, reticle R is loaded into load/unload ports 22A and 22B, in a state housed within sealed type reticle carriers 28₁ and 28₂. This allows reticle R to be brought into main body chamber 12 in a state where the inside of main body chamber 12 is isolated from the outside. Furthermore, the degree of cleanliness in main body chamber 12 is maintained at a class 1 level, therefore, adhesion of contaminated materials such as particles on the reticles inside main body chamber 12 can be prevented effectively.

Accordingly, with exposure apparatus 10 of the embodiment, adhesion of contaminated materials, such as particles on the reticles that decreases the exposure accuracy, can be prevented for over a long period of time. Therefore, exposure with high precision using such reticles becomes possible for over a long period of time.

In addition, since adhesion of contaminated materials such as particles on the reticles inside main body chamber 12 can be prevented effectively as is described above, the particle inspection does not have to be performed frequently, and only has to be performed prior to loading the reticle into buffer 116. As a consequence, the control sequence that includes the particle inspection can be simplified. As a matter of course, the particle inspection can be performed at a predetermined interval. In such a case, the interval can be prolonged.

Incidentally, particle inspection unit 34 does not necessarily have to be arranged within main body chamber 12, and, for example, the particle detection on the reticle may be performed outside main body chamber 12, the reticle housed into a sealed type reticle carrier, and then loaded in main body chamber 12.

In the embodiment above, the case has been described where open/close door 128 of buffer 116 is opened/closed only when the reticle is put in or taken out. The present invention, however, is not limited to this. For example, main controller 50 may normally keep open/close door 128 of buffer 116 open at all times, and may close open/close door 128 when it detects that open/close doors 18A and 18B or the like have been opened. This can be achieved, by fixing a sensor on any one of open/close doors 18A, 18B and main body chamber 12 to detect whether open/close doors 18A and 18B or the like are open. And, based on the output of the sensor, main controller 50 can then detect whether open/close doors 18A and 18B or the like have been opened.

Or, main controller 50 may check the degree of air purification in main body chamber 12 and control the state of open/close door 128, so that while the degree of air purification is higher than a predetermined value the door may be opened, whereas when the degree of air purification is lower than the predetermined value the door may be closed. This can be achieved, for example, by main controller 50 detecting the degree of air purification inside main body chamber 12 based on the output of a particle check sensor, which is arranged within main body chamber 12. In addition, with this arrangement, for example, when the air conditioning is resumed in main body chamber 12 after open/close doors 18A and 18B have been opened during maintenance and then closed when the maintenance is completed, the door of buffer 116 automatically opens when the degree of air purification inside main body chamber 12 exceeds the predetermined value.

Incidentally, impurities concentration may be detected instead of the degree of air purification, or the door of buffer 116 may be opened, only after a predetermined period of time has elapsed after closing open/close doors 18A and 18B.

Incidentally, in buffer 116 of the above embodiment, a barrier film consisting of a high-velocity gas flow which flows vertically downward that closes the opening provided in buffer 116 for putting in or taking out the reticle when open/close doors 18A and 18B of main body chamber 12 are open, may be utilized as the open/close mechanism, along with open/close door 128, or instead of open/close door 128. For example, such a barrier film, consisting of a high-velocity airflow that flows vertically downward, may be an air curtain. Such a barrier film consisting of a high-velocity gas flow can prevent the flow of outside air from entering the buffer 116, and can also prevent the movement of heat. Therefore, adhesion of contaminated materials such as particles on the reticles inside buffer 116 can be prevented or effectively suppressed. Main controller 50 may control the on/off operation of the air curtain, depending on the open/close state of the door of main body chamber 12, or the degree of air purification inside main body chamber 12.

In addition, when an open type buffer is used as buffer 116, a clean gas (a gas that is chemically clean, in addition to hardly containing any particles) such as dry air is preferably supplied to the buffer from gas supply mechanism 134 at al times. With this arrangement, the reticles can be stocked within main body chamber 12 as much as necessary, and even when the door of main body chamber 12 is opened during the maintenance period, contaminated materials such as particles entering buffer 116 can be effectively suppressed.

The clean gas may be supplied to buffer 116 at all times from gas supply mechanism 134, regardless of the open/close of open/close doors 18A and 18B, or the inside of buffer 116 may be filled with the clean gas and almost sealed. Or, the clean gas may be supplied to buffer 116 from gas supply mechanism 134 only when open/close doors 18A and 18B are open, or the inside of buffer 116 may be filled with the clean gas in an almost sealed state before opening open/close doors 18A and 18B. In any case, when the reticles are stocked in buffer 116 for a long time, adhesion of contaminated materials such as particles on the reticles can be prevented or effectively suppressed.

In addition, gas supply mechanism 134 may supply the clean gas into the buffer only when open/close door 128 is open, or may continue to supply the clean gas regardless of the state of open/close door 128. Especially in the former case, when open/close door 128 is closed, buffer 116 may be filled with the clean gas and an almost sealed state created. In addition, gas supply mechanism 134 may supply the clean gas into the buffer only when open/close door 128 and at least one of the open/close doors 18A and 18B are opened at the same time.

In the embodiment, by the various methods described so far, contaminated materials are suppressed from entering into the buffer from the area outside of where the buffer is arranged, and in this sense, it can be said that these methods structure a suppress mechanism related to the present invention. The suppress mechanism, however, is not limited to the ones above. For example, the buffer case may be formed of a box-type member with an opening on one side, and in the case at least a part of the opening is arranged as the in/out opening of the mask (which concept includes the reticle), the suppress mechanism can be made up of a shutter, preferably a high-velocity shutter which operates at a high speed, utilized for opening/closing the opening. Or, in the case a part of the opening is arranged as the in/out opening of the mask, the suppress mechanism can be structured by an air filter, which is arranged on the periphery area of the opening. Further, in the case a part of the opening is arranged as the in/out opening of the mask, the holding member of the mask inside the buffer case may be structured vertically movable. In this way, the configuration of the suppress mechanism is not specifically limited, and no matter what method it employs, it only has to consequently reduce, or eliminate the amount of contaminated materials entering into the buffer from outside the area where the buffer is arranged. And, when the apparatus comprises such a suppress mechanism, the suppress mechanism suppresses the contaminated materials from entering into the buffer. Therefore, for example, in the case where the masks are stocked inside the buffer for over a long period of time, adhesion of contaminated materials on the masks can be prevented or effectively suppressed.

The configuration of the main body chamber, buffer, and other parts described in the embodiment above, is an example, and as a matter of course, the present invention is not limited to this. For example, main body chamber 12 that houses exposure apparatus main body 30 may have only one load/unload port arranged for the mask container (reticle carrier). In this case, only one reticle carrier can be loaded into main body chamber 12. By loading the reticle carrier into the load/unload port several times, however, the reticles can be housed in buffer 116 to the maximum, since each time the reticle carrier is loaded reticle carrier system 32 loads the reticle into buffer 116 from the reticle carrier. Accordingly, it becomes possible for the apparatus to keep the reticles necessary for exposure at all times within itself.

In addition, in the embodiment above, exposure apparatus main body 30, reticle carrier system 32, and the wafer carrier system (omitted in Figs.) are arranged within main body chamber 12. Alternatively, for example, main body chamber 12 may be partitioned plurally to house the exposure apparatus main body, the reticle carrier system, and the wafer carrier system separately. Or, the exposure apparatus main body, the reticle carrier system, and the wafer carrier system and the line may be housed in a plurality of chambers.

In addition, as is shown in FIG. 4, the case has been described where open/close door 128 of buffer 116 opens only on one side. Instead of this door, double doors that open outward may be arranged on the opening side of buffer main body case 122.

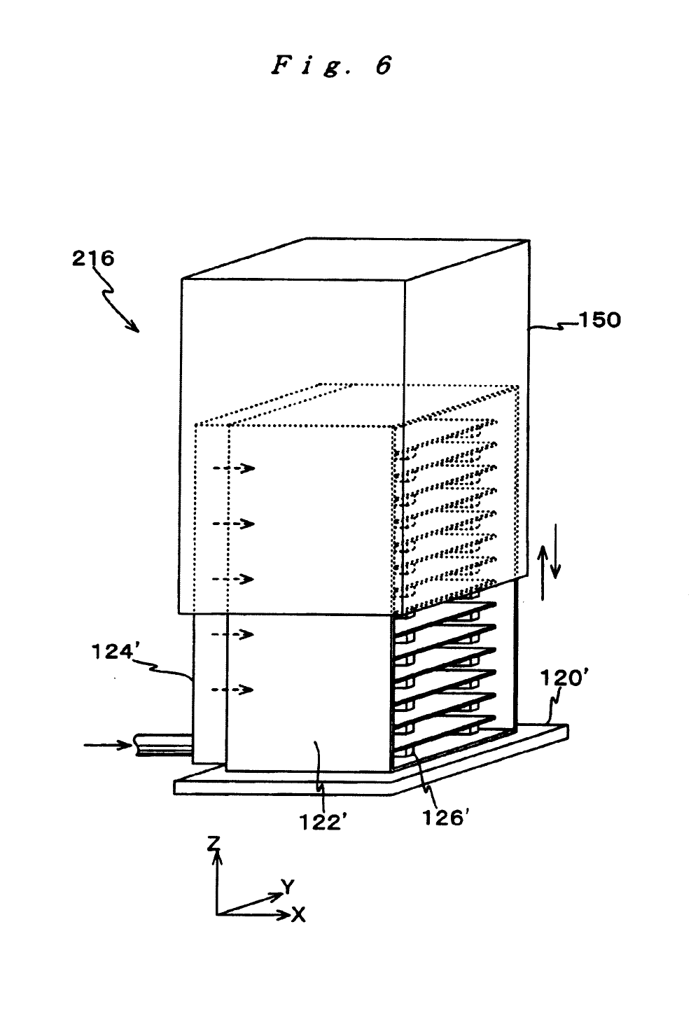

Or, a buffer 216 may be used, as is shown in FIG. 6. Buffer 216 comprises: a buffer main body case 122′, in which a mask housing shelf 126′, being a plurality of shelves (for example, fourteen) arranged in the vertical direction at a predetermined interval, is arranged; an air exhaust mechanism 124′, which is attached to the back side of the buffer main body case 122′; a base portion 120′, which is fixed to the lower surface of the buffer main body case 122′; and a cover 150, which is a hollow box-type cover with an opening on the bottom surface that can be attached/detached from above. When the cover 150 is attached to base portion 120′ creating a “closed” state, a closed space is formed in the inside, whereas when cover 150 is detached from base portion 120′ creating an “open” state, the shelves of mask housing shelf 126′ are exposed, depending on the degree of opening.

In this case, an arrangement may be employed where base portion 120′ and buffer main body case 122′ are fixed, and cover 150 moves vertically with respect to these parts to cover buffer main body case 122′ from above, or cover 150 may be fixed, and both base portion 120′ and buffer main body case 122′ may move vertically with respect to cover 150. In the latter case, when the number of masks that need to be housed in the buffer is around six, it is possible to use the reticle carrier previously described (SMIF pod) as the buffer. As a matter of course, it is possible to use a buffer with an inverted structure of the buffer in FIG. 6.

In addition, one buffer is arranged in the embodiment above, however, the buffer arranged may be more than one.

In the embodiment above and the modified example in FIG. 6, the case has been described where a buffer is used in which a plurality of reticles are housed in a single space. The present invention, however, is not limited to this, and a reticle library comprising a plurality of shelves where a plurality of reticle cases that individually house a reticle can be put in/taken out may be arranged. In this case, the buffer may be formed of the reticle library and the reticle case.

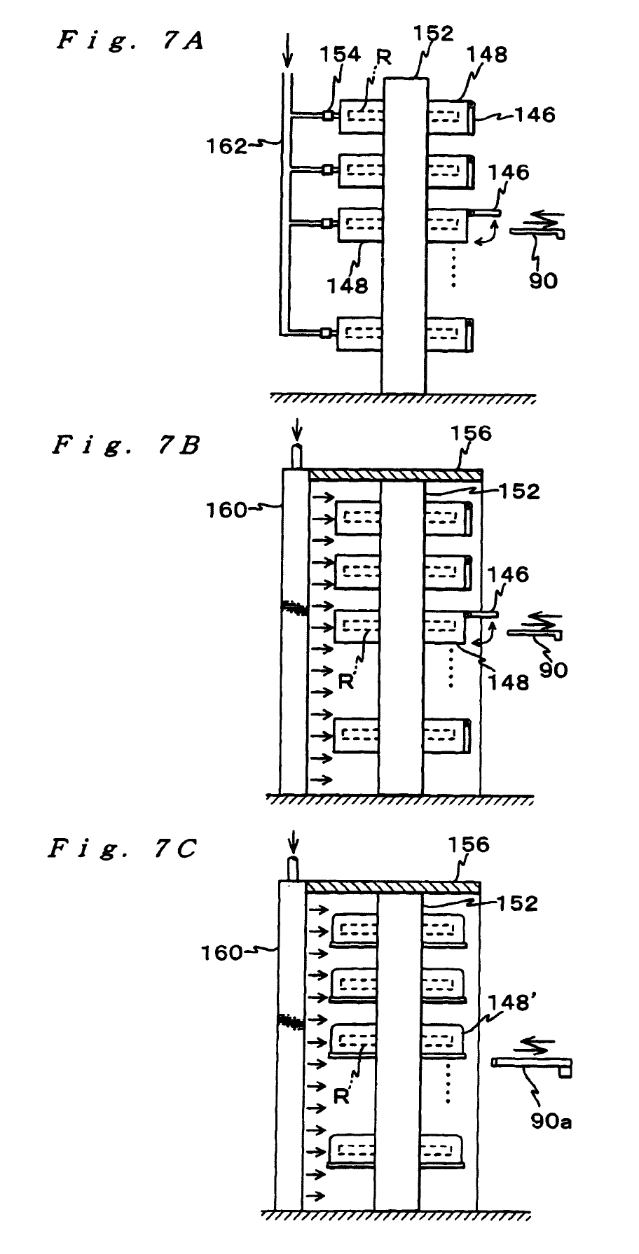

FIGS. 7A to 7C show modified examples of various buffers making up such a reticle library. Of these drawings, in FIG. 7A, reticle cases 148 to which a door 146 used for opening/closing on the front side is attached to each case via a hinge are housed in each of the shelves of a reticle library 152, and to each of the reticle cases a supply piping 162 for supplying clean air is connected via a pneumatic joint 154. In this case, a half sealed state is created instead of a sealed state inside each reticle case 148, when door 146 is closed. The reticles R are individually housed inside each reticle case 148, and are put in/taken out by arm 90 when door 146 is open.

In addition, in FIG. 7B, a frame 156 covers the upper surface and the side surfaces of reticle library 152 housing a plurality of reticle cases 148 similar to the ones in FIG. 7A. And, on the back surface of frame 156, an air exhaust mechanism 160, which is similar to exhaust mechanism 124 described earlier, is arranged. In this case, a box having an opening on one side (the reticle stage side) is formed, with frame 156 and the housing of air exhaust mechanism 160. In this case, air exhaust mechanism 160 supplies clean air to the entire inside of the box. And, in this case, the reticles housed inside each reticle case 148 are put in/taken out by arm 90 when door 146 is open.

Likewise FIG. 7B, in FIG. 7C, frame 156 covers the upper surface and the side surfaces of reticle library 152 housing a plurality of the reticle cases, and on the back surface of frame 156, air exhaust mechanism 160, which is similar to exhaust mechanism 124 described earlier, is arranged. In this case, however, as the reticle case, a reticle case 148′, which is vertically separable, is used. In this case, to take out the reticles R out from inside each reticle case 148′, reticle case 148′ is taken out with a carrier arm 90a, which is similar to arm 90, and carried to a predetermined separation position. The reticle case is then vertically separated at the position, and carried by arm 90.

In the modified examples in FIGS. 7A to 7C described above, the advantages are that on emergencies such as when the automatic carrier system for the reticles has stopped, or the exposure apparatus has stopped due to failure, the operator can individually take out the reticles (reticle case). However, in the case in FIG. 7A, an air piping connected via each pneumatic joint is preferably easy to disconnect, and furthermore, in the cases in FIGS. 7A and 7B, air exhaust mechanism 160is preferably easy to detach.

In addition, the buffer does not necessarily have to house a plurality of reticles arranged in the vertical direction. The buffer used in the exposure apparatus of the present invention may have any configuration, so long as a plurality of masks can be put in/taken out and housed.

Further, in the embodiment above, the case has been described where the SMIF multi-pod (for 6 masks) is used as the mask container. The present invention, however, is not limited to this, and the single pod (for a single mask) may be used, as well as a FOUP type reticle carrier (mask container).

In addition, in the embodiment above, the case has been described where dry air is supplied to the buffer as a clean gas from gas supply mechanism 134. It is possible, however, to use nitrogen or other gases as the clean gas. Similarly, the air curtain, previously described, may be formed of gases such as nitrogen gas. In the case of an exposure apparatus using the ArF excimer laser as the light source, the air along the optical path of the exposure light is sometimes replaced with gases such as nitrogen gas to prevent the transmittance of the exposure light from decreasing. In such a case, nitrogen or other gases are preferably supplied as the clean gas.

In addition, the configuration of the reticle carrier system in the embodiment above is an example, and an arbitrary configuration may be employed. For example, interim delivery portion 106 does not have to be arranged, and the reticle may be carried between buffer 116 and reticle stage RST only by the reticle slide movement mechanism. Furthermore, the OHV does not necessarily have to be used, and the operator can manually perform the reticle exchange.

In addition, when the number of reticles housed in buffer 116 is less than the number of reticles used in the process, or when a plurality of processes are performed chronologically, the reticles that are to be used may not be housed in buffer 116. In such a case, an operation of taking the reticle that has been already used and will not be used for the meantime out from buffer 116 and exchanging it with the reticle that is to be used may be performed in parallel with the exposure process earlier described. For example, the reticles within the buffer can be updated at all times so that they correspond with the process that follows, based on a process program. In this case, the reticles are housed sequentially in the buffer depending on a priority order (the priority is higher when used early), and at the point when exposure using the reticles with higher priority is completed, the reticles used can be taken out of the buffer and reticles that are to be used immediately after the reticles housed most recently can be loaded into the buffer.

In the embodiment above, the case has been described where the present invention has been applied to a scanning exposure apparatus based on a step-and-scan method. The present invention, however, is not limited to this, and can be suitably applied to a step-and-repeat type exposure apparatus, which transfers a pattern on a mask onto a substrate in a state where the mask and the substrate are static, while performing stepping operations sequentially on the substrate in between the transfer. In addition, the present invention can be applied to a proximity exposure apparatus, which transfers a pattern on a mask onto a substrate without using a projection optical system, with the mask and the substrate in close contact.

In addition, the present invention can be applied not only to an exposure apparatus for manufacturing semiconductor devices, but also to an exposure apparatus used when manufacturing displays including liquid crystal display devices for transferring a device pattern onto a glass plate, or to an exposure apparatus used when manufacturing thin film magnetic heads for transferring a device pattern onto a ceramic wafer, or an exposure apparatus used when manufacturing pick-up devices (such as a CCD), micromachines, and DNA chips, or the like.

In addition, the present invention can be applied to an exposure apparatus not only for manufacturing microdevices such as a semiconductor device, but also to an exposure apparatus which transfers a circuit pattern onto a glass substrate or a silicon wafer when manufacturing reticles and masks that are used in an optical exposure apparatus, an EUV exposure apparatus, an X-ray exposure apparatus, and an electron beam exposure apparatus, or the like. Normally, an exposure apparatus that uses DUV (Deep Ultraviolet) light or VUV (Vacuum Ultraviolet) light uses a transmittance type reticle, and as a reticle substrate materials such as silica glass, fluorine-doped silica glass, fluorite, magnesium fluoride, or crystal are used.

With the exposure apparatus in the present invention, not only the KrF excimer laser (248 nm) or the ArF excimer laser (193 nm) may be used as the light source, but also an ultra-high pressure mercury lamp may be used. When the ultra-high pressure mercury lamp is used, emission lines such as a g line (436 nm) or an i line (365 nm) may be used as illumination light for exposure. In addition, the F₂ laser (157 nm) or the Ar₂ laser may be used as the light source. Or a metal vapor laser, or a YAG laser, and the like may be used as the light source, and these harmonics may be used as the illumination light for exposure. Or a harmonic may be used as the illumination light for exposure, which is obtained by amplifying a single-wavelength laser beam in the infrared or visible range emitted by a DFB semiconductor laser or fiber laser, with a fiber amplifier doped with erbium (Er)(or both erbium and ytteribium (Yb)), and by converting the wavelength into ultraviolet light using a nonlinear optical crystal.

In addition, the magnification of the projection optical system is not limited to a reduction system, but may also be of equal magnification or an enlarged magnification. Furthermore, the optical system of the projection optical system is not limited to the refraction system, and a reflection refraction system or a reflection system can also be used.

Semiconductor devices are manufactured through the following steps: the step of designing the function and performance of the device; the step of manufacturing a reticle on the basis of the design step; the step of manufacturing a wafer from a silicon material; the step of transferring a reticle pattern onto the wafer by using the exposure apparatus of the above embodiment; the step of assembling the device (including dicing, bonding, and packaging process), the inspection step, and the like. Specifically, following is a detailed description of a device manufacturing method.

<<Device Manufacturing Method>>

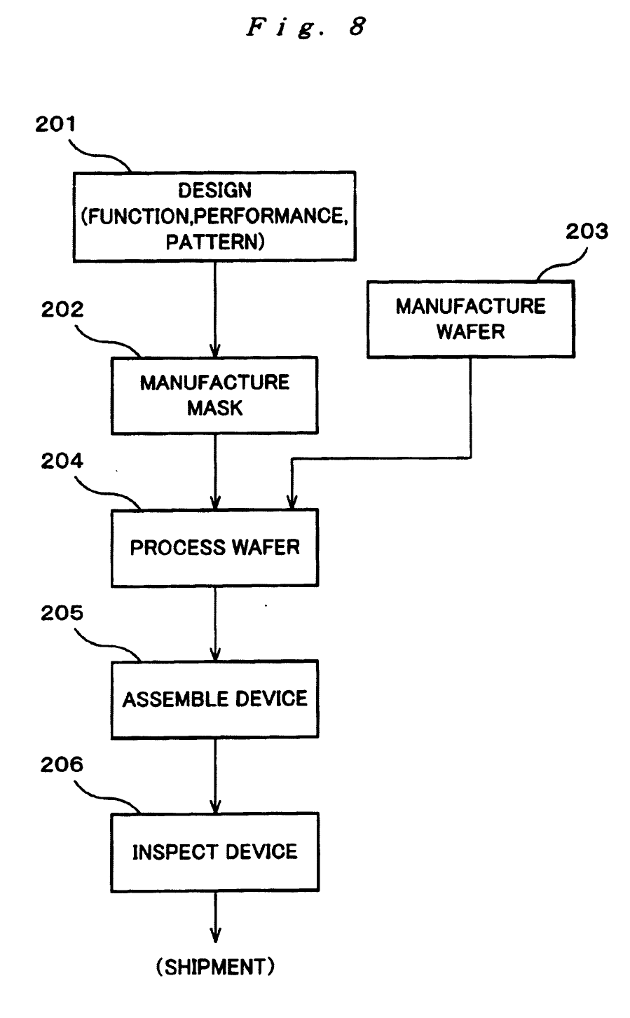

FIG. 8 is a flow chart showing an example of manufacturing a device (a semiconductor chip such as an IC or LSI, a liquid crystal panel, a CCD, a thin magnetic head, a micromachine, or the like). As shown in FIG. 8, in step 201 (design step), function/performance is designed for a device (e.g., circuit design for a semiconductor device) and a pattern to implement the function is designed. In step 202 (mask manufacturing step), a mask on which the designed circuit pattern is formed is manufactured. In step 303 (wafer manufacturing step), a wafer is manufacturing by using a silicon material or the like.

In step 204 (wafer processing step), an actual circuit and the like is formed on the wafer by lithography or the like using the mask and wafer prepared in steps 201 to 203, as will be described later. Next, in step 205 (device assembly step) a device is assembled using the wafer processed in step 204. The step 205 includes processes such as dicing, bonding, and packaging (chip encapsulation), as necessary.

Finally, in step 206 (inspection step), a test on the operation of the device, durability test, and the like are performed. After these steps, the device is completed and shipped out.

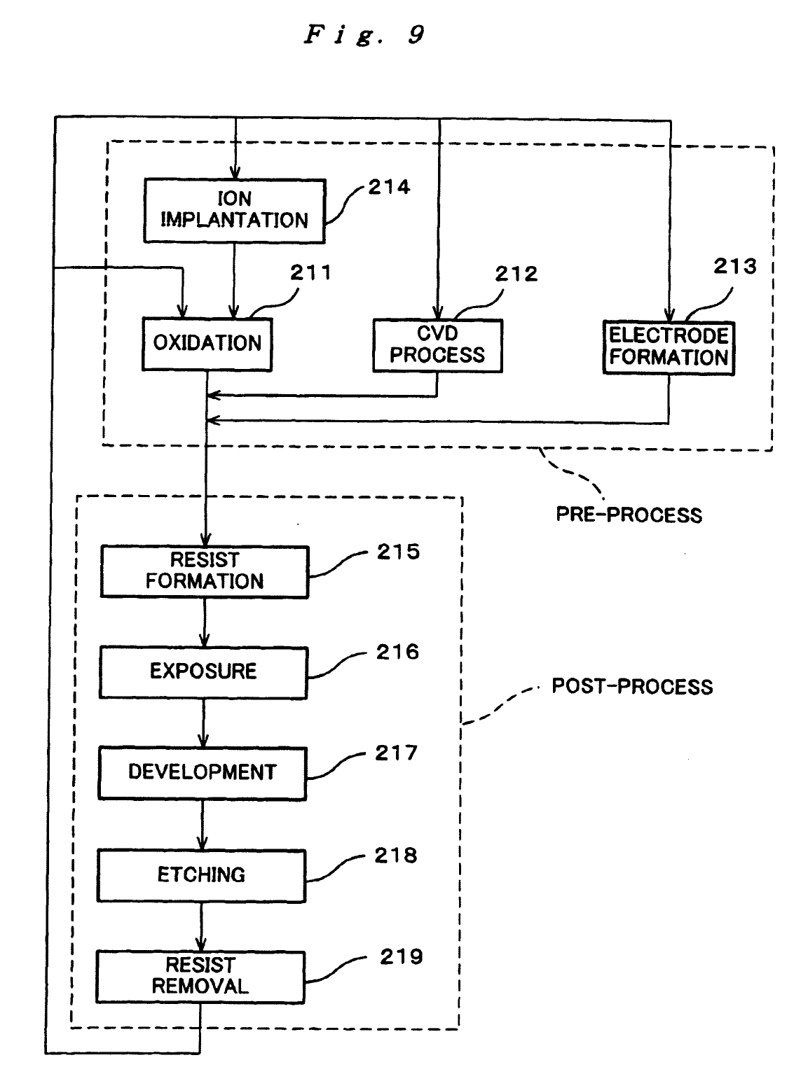

FIG. 9 is a flow chart showing a detailed example of step 204 described above in manufacturing the semiconductor device. Referring to FIG. 9, in step 211 (oxidation step), the surface of the wafer is oxidized. In step 212 (CVD step), an insulating film is formed on the wafer surface. In step 213 (electrode formation step), an electrode is formed on the wafer by vapor deposition. In step 214 (ion implantation step), ions are implanted into the wafer. Steps 211 to 214 described above constitute a pre-process for the respective steps in the wafer process and are selectively executed based on the processing required in the respective steps.

When the above pre-process is completed in the respective steps in the wafer process, a post-process is executed as follows. In this post-process, first, in step 215 (resist formation step), the wafer is coated with a photosensitive agent. Next, as in step 216, the circuit pattern on the mask is transferred onto the wafer by the exposure apparatus described in the embodiment. Then, in step 217 (developing step), the exposed wafer is developed. In step 218 (etching step), an exposed member of an area other than the area where the resist remains is removed by etching. Finally, in step 219 (resist removing step), when etching is completed, the resist that is no longer necessary is removed.

By repeatedly performing these pre-process and post-process steps, multiple circuit patterns are formed on the wafer.

When using the device manufacturing method described so far in the embodiment, the exposure apparatus of the present invention such as the exposure apparatus 10 in the above embodiment is used in the exposure process (step 216). This can prevent adhesion of contaminated materials on the mask, and can effectively suppress situation such as decrease in exposure accuracy. Therefore, high integration devices can be manufactured with high yield, consequently improving the productivity.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An exposure apparatus comprising:
an exposure apparatus main body which transfers a pattern of a mask mounted on a mask stage onto a substrate;
a chamber which houses said exposure apparatus main body and has at least one load/unload port for a sealed type mask container arranged, said container capable of housing a specific number of said masks;
a buffer arranged on a mask carrier route along from said load/unload port to said mask stage in which a predetermined number of masks more than said specific number of masks can be put in, taken out, and housed; and
a mask carrier system which carries said mask between said load/unload port, said buffer, and said mask stage.

2. The exposure apparatus according to claim 1, said exposure apparatus further comprising:
a suppress mechanism which suppresses contaminated materials from entering into said buffer from outside an area where said buffer is arranged.

3. The exposure apparatus according to claim 1, said exposure apparatus further comprising:
a gas supply mechanism that can supply clean gas into said buffer.

4. The exposure apparatus according to claim 3, wherein said gas supply mechanism supplies said clean gas into said buffer at all times.

5. The exposure apparatus according to claim 3, said exposure apparatus further comprising:
an open/close portion that can open and close arranged in said chamber.

6. The exposure apparatus according to claim 5, wherein said gas supply mechanism supplies said clean gas to said buffer only while said open/close portion is open.

7. The exposure apparatus according to claim 5, wherein
said buffer has an open/close mechanism that can open and close, and
said gas supply mechanism supplies said clean gas into said buffer at least when said open/close mechanism is open.

8. The exposure apparatus according to claim 7, wherein said gas supply mechanism supplies said clean gas into said buffer at all times.

9. The exposure apparatus according to claim 7, wherein said gas supply mechanism supplies said clean gas into said buffer only while said open/close mechanism is open.

10. The exposure apparatus according to claim 9, wherein said buffer is filled with said clean gas in a state almost sealed, while said open/close mechanism is closed.

11. The exposure apparatus according to claim 5, wherein
said buffer has an open/close mechanism that can open and close, and
said gas supply mechanism supplies said clean gas into said buffer only while said open/close portion and said open/close mechanism are both open.

12. The exposure apparatus according to claim 3, wherein said buffer has an open/close mechanism that can open and close, and can create a state almost sealed within said buffer in a closed state.

13. The exposure apparatus according to claim 12, wherein said gas supply mechanism supplies said clean gas into said buffer only while said open/close mechanism is open.

14. The exposure apparatus according to claim 13, wherein said buffer is filled with said clean gas, while said open/close mechanism is closed.

15. The exposure apparatus according to claim 12, said exposure apparatus further comprising:
a control unit which opens and closes said open/close mechanism each time said mask is put in and taken out of said buffer.

16. The exposure apparatus according to claim 12, said exposure apparatus further comprising:
a control unit which opens and closes said open/close mechanism depending on a degree of cleanliness within said chamber.

17. The exposure apparatus according to claim 1, wherein said buffer has an open/close mechanism that can cut off its inside from outside air.

18. The exposure apparatus according to claim 17, said exposure apparatus further comprising:
an open close portion that can open and close arranged in said chamber; and
a control unit which controls said open/close mechanism depending on a state of said open/close portion.

19. The exposure apparatus according to claim 18, wherein said open/close mechanism is a barrier film consisting of a high-velocity gas flow that closes an entrance of said mask arranged at said buffer when said open/close portion is open.

20. The exposure apparatus according to claim 17, said exposure apparatus further comprising:
a control unit which controls said open/close mechanism depending on a degree of cleanliness within said chamber.

21. The exposure apparatus according to claim 17, said exposure apparatus further comprising:
a control unit which opens and closes said open/close mechanism each time said mask is put in and taken out of said buffer.

22. The exposure apparatus according to claim 1, wherein said buffer is formed of a single space with a plurality of masks housed therein.

23. The exposure apparatus according to claim 1, wherein said buffer comprises a plurality of spaces that can house at least one mask inside each space.

24. The exposure apparatus according to claim 1, said exposure apparatus further comprising:
a particle inspection unit that inspects an adhered state of said particles on said mask, said particle inspection unit arranged on a mask carrier route along from said load/unload port to said mask stage.

25. The exposure apparatus according to claim 24, said exposure apparatus further comprising:
a reading unit that reads information regarding said mask provided on said mask, said reading unit arranged on a mask carrier route along from said load/unload port to said mask stage.

26. A device manufacturing method including a lithographic process, wherein in said lithographic process exposure is performed using said exposure apparatus according to claim 1.

27. An exposure apparatus according to claim 1, wherein
a plurality of said mask containers can be arranged in said load/unload port, and
said predetermined number of masks that can be housed in said buffer is more than a number of masks that can be housed in said plurality of mask containers.

28. An exposure apparatus according to claim 27, said exposure apparatus further comprising:
a suppress mechanism which suppresses contaminated materials from entering said buffer from outside the area where the buffer is arranged.

29. An exposure apparatus according to claim 27, said exposure apparatus further comprising:
a gas supply mechanism that can supply clean gas into said buffer.

30. An exposure apparatus according to claim 27, wherein said buffer has an open/close mechanism that can cut off its interior from outside air.

31. An exposure apparatus according to claim 27, wherein said buffer is formed of a single space with a plurality of masks housed therein.

32. An exposure apparatus according to claim 27, wherein said buffer comprises a plurality of spaces that can house at least one mask inside each space.

33. An exposure apparatus according to claim 27, said exposure apparatus further comprising:
a particle inspection unit that inspects an adhered state of said particles on said mask, said particle inspection unit arranged on a mask carrier route along from said load/unload port to said mask stage.

34. A device manufacturing method including a lithographic process, wherein in said lithographic process exposure is performed using said exposure apparatus according to claim 27.
